(19) United States
(12) Patent Application Publication
(10) Pub. No.: US 2025/0369679 A1
(43) Pub. Date: Dec. 4, 2025

(54) REFRIGERATING MECHANISM FOR PIPELINE OF AUTOMATIC BUBBLE TEA MACHINE

(71) Applicant: Dongguan ZEEWAY-Technology Ltd, Guangdong Province (CN)

(72) Inventors: Mengyi Zhu, Guangdong Province (CN); Fulin Lv, Guangdong Province (CN)

(73) Assignee: Dongguan ZEEWAY-Technology Ltd, Guangdong Province (CN)

(21) Appl. No.: 18/988,845

(22) Filed: Dec. 19, 2024

(30) Foreign Application Priority Data
May 30, 2024 (CN) 2024212119561

(51) Int. Cl. F25D 17/08; F25D 31/00

(52) U.S. Cl. CPC F25D 17/08; F25D 31/002; F25D 2323/0027; F25D 2323/00284

(57) ABSTRACT

The present disclosure relates to a refrigerating mechanism for pipeline of an automatic bubble tea machine, comprising a cold air interaction box, a ventilation structure, an air intake structure and an air exchange structure. The air intake structure and the air exchange structure are installed in a refrigerator box. The cold air interaction box is installed on an upper end of the refrigerator box and is communicated with the air intake structure and the air exchange structure. The ventilation structure is installed in an installing box and is communicated with the cold air interaction box. The above refrigerating mechanism can transport cold air to the cold air interaction box through the air intake structure, circulate the cold air in the installing box through the ventilation structure, and finally transport the circulated cold air back to the refrigeration box through the ventilation structure continuously, so as to reduce temperature in the installation box, maintain refrigeration state of the installation box, realize refrigeration of slurry pipeline, and prevent slurry in the pipeline from deteriorating, which will affect taste of a beverage.

### TECHNICAL FIELD

The present disclosure relates to technical field of bubble tea machine, and especially to a refrigerating mechanism for pipeline of an automatic bubble tea machine.

### BACKGROUND

With improvement of living standards, demand and consumption levels for beverage consumption are also rising, making freshly-made beverage shops become one of fast-growing industries. The freshly-made beverage shops can be found everywhere, and a hot scene with a waiting line often can be seen.

Current in freshly-made beverage shops, beverages are mostly prepared by manual, and to meet needs of different consumers, a wide variety of beverages are provided. However, there are still problems of low efficiency of beverage preparation and unstable taste of prepared liquid. Especially for beverages of viscous liquid such as yogurt, it is difficult to automatically dispense precise amount of this type of viscous liquid.

In order to above technical problems, a Chinese patent has disclosed an automatic bubble tea machine (application No. 201810140651.9), which comprises a low-temperature preservation box, an ice preparation machine box, and a room temperature box. A guide rail box is provided in front of the boxes. Upper part in the low-temperature preservation box is equipped with a sauce output device, a large fruit granule output device, a covering ingredient output device, and a juice pump. Middle part in the low-temperature preservation box is equipped with a juice barrel. A fully automatic ice preparation machine is provided in the ice preparation machine box. Upper part in the room temperature box is equipped with a cup dropper, a fructose output device, a powder ingredient output device, and a stirring device. Middle part in the room temperature box is equipped with tea and purified water outlets. Lower part in the room temperature box is a storage area for a water bucket. There is a bubble tea cup conveying platform provided inside the guide rail box. However, in the above-mentioned bubble tea machine, only the low-temperature preservation box has a function of refrigeration. After completion of outputs of the sauce output device, the large fruit granule output device, the covering ingredient output device and the juice pump, slurry in them stays in pipeline thereof at room temperature, which is prone to spoilage and will affect taste and flavor of the bubble tea prepared.

### SUMMARY

Main purpose of the present disclosure is to provide a refrigerating mechanism for pipeline of an automatic bubble tea machine, in order to solve the above technical problems, which is able to refrigerate the slurry pipeline.

In order to realize the above purpose, the present disclosure adopts the following technical solutions:

A refrigerating mechanism for pipeline of an automatic bubble tea machine is provided that comprises a cold air interaction box, a ventilation structure, an air intake structure and an air exchange structure. The air intake structure and the air exchange structure are installed in a refrigerator box. The cold air interaction box is installed on the upper end of the refrigerator. The cold air interaction box is communicated with the air intake structure and the air exchange structure. The ventilation structure is installed in an installing box and is communicated with the cold air interaction box.

As a preferred technical solution, the air intake structure comprises a cold air intake

fan and an air intake chamber. The air intake chamber is installed in the refrigerator box. The cold air intake fan is installed in the air intake chamber. The air intake chamber is communicated with the cold air interaction box through an air exchange channel.

As a preferred technical solution, the air exchange structure comprises a cold air exchange fan and air exchange chamber. The air exchange chamber is installed in the refrigerating box. The cold air exchange fan is installed in the air exchange chamber. The air exchange chamber is communicated with the cold air interaction box through an air exchange channel.

As a preferred technical solution, the ventilation structure comprises a ventilation channel, an air intake fan and an exhaust fan. The air intake fan and the exhaust fan are installed at each end of the ventilation channel, respectively.

As a preferred technical solution, the ventilation channel comprises a transverse channel and two longitudinal channels. The two ends of the transverse channels are respectively communicated with each of the two longitudinal channels. The air intake fan and the exhaust fan are respectively installed in one end of each of two longitudinal channels.

As a preferred technical solution, the refrigerating box is provided with an air exchange channel. The cold air interaction box is communicated with the air intake structure and the air exchange structure through an air exchange channel.

The beneficial effects of the present disclosure lie in that the above refrigerating mechanism for pipeline of the bubble tea machine can transport cold air to the cold air interaction box through the air intake structure, circulate the cold air in the installing box through the ventilation structure, and finally transport the circulated cold air back to the refrigeration box through the ventilation structure continuously, so as to reduce temperature in the installation box, maintain refrigeration state of the installation box, realize refrigeration of slurry pipeline, and prevent slurry in the pipeline from deteriorating, which will affect taste of a beverage.

### BRIEF DESCRIPTION OF FIGURES

FIG. 1 shows a perspective view of an automatic bubble tea machine involved in the present disclosure;

FIG. 2 shows another perspective view of the automatic bubble tea machine involved in the present disclosure;

FIG. 3 shows a right view of the automatic bubble tea machine involved in the present disclosure;

FIG. 4 shows a left view of the automatic bubble tea machine involved in the present disclosure;

FIG. 5 shows a rear view of the automatic bubble tea machine involved in the present disclosure;

FIG. 6 shows a perspective sectional view of the automatic bubble tea machine involved in the present disclosure.

### DETAILED DESCRIPTION

In order to more clearly explain purpose, technical solution and advantages of the present disclosure, the present disclosure is described in detail hereinafter in conjunction with accompanying drawings and embodiments. It should be understood that specific embodiments described here are intended only to explain the present disclosure and not to limit the present disclosure.

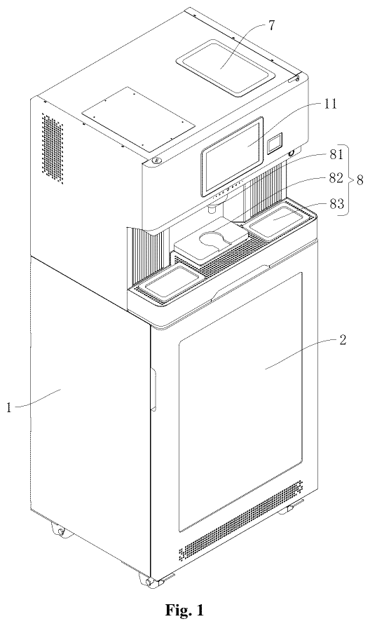

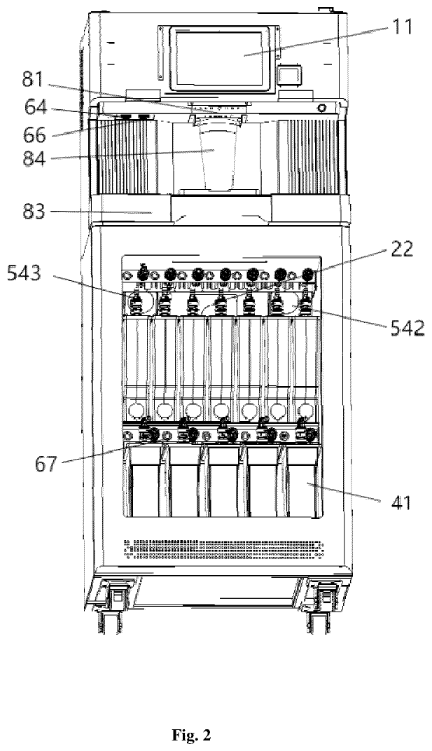

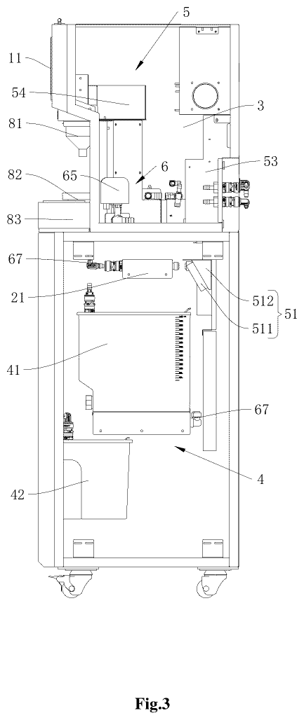

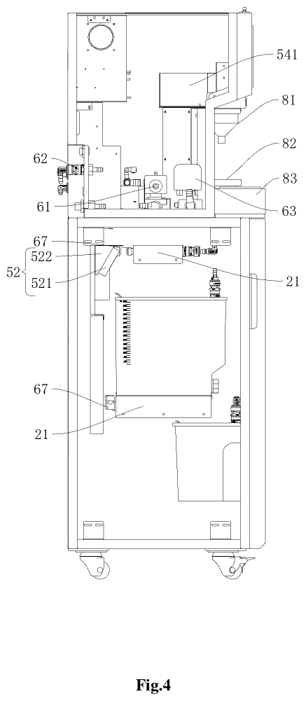

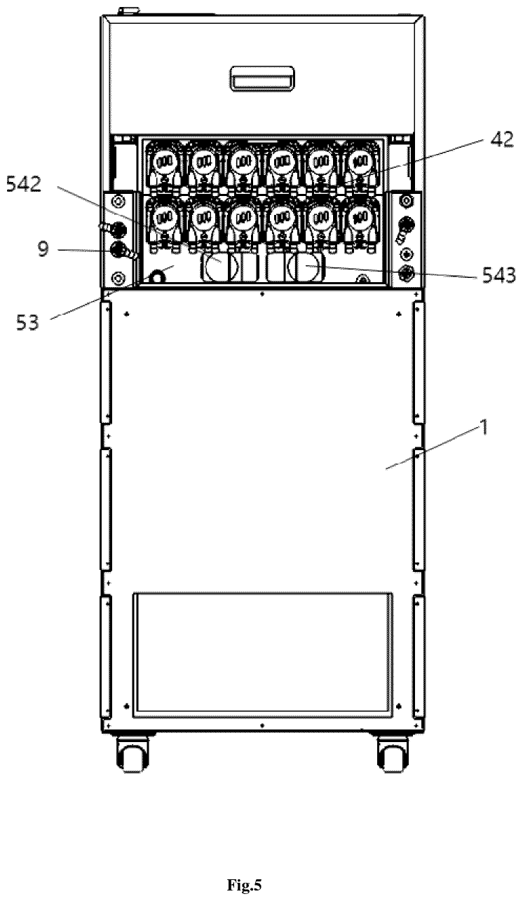

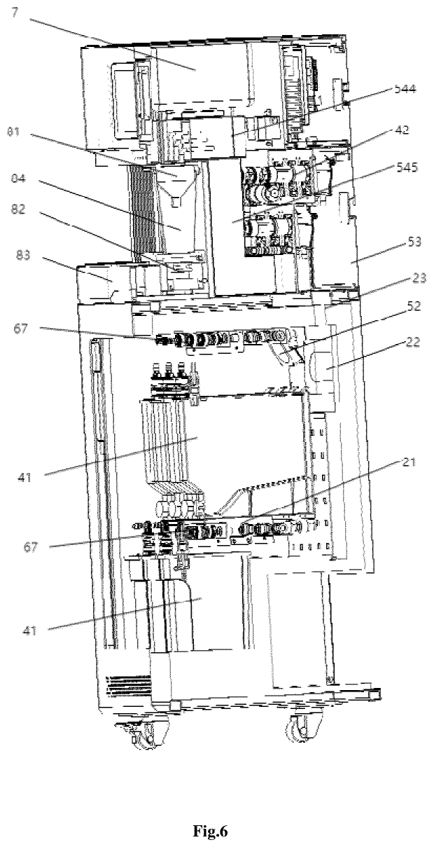

As shown in connection with FIG. 1-FIG. 6, an automatic bubble tea machine comprises a rack 1, a refrigerator box 2, an installing box 3, a slurry dispensing mechanism 4, a refrigerating mechanism for pipeline 5, a syrup dispensing mechanism 7, an outlet mechanism 8, and a leaning system for pipeline 6. The refrigerator box 2 is installed on a lower end of the rack 1. The installing box 3 is installed on an upper end of the refrigerator box 2. The outlet mechanism 8 is installed on outside of the rack 1. The slurry dispensing mechanism 4, the refrigerating mechanism for pipeline 5, and the cleaning system for pipeline 6 are installed on the installing box 3. The syrup dispensing mechanism 7 is provided above the outlet mechanism 8. The slurry dispensing mechanism 4 and the syrup dispensing mechanism 7 are communicated with the outlet mechanism 8, respectively. The refrigerator box 2 is used for storing slurry that needs to be refrigerated. In this embodiment, the slurry dispensing mechanism 4 is provided with a plurality of slurry dispensing mechanisms 4 used for storing slurries with different ingredients and used for preparing beverages with different flavors. The slurry dispensing mechanism 4 can dispense different slurries with different ingredients to the outlet mechanism 8 according to ratios. In particular, seventeen slurry dispensing mechanisms are provided in this embodiment, which can satisfy ratios of different flavor beverages in market. The outlet mechanism 8 is used for outputting slurries to form a beverage. The refrigerating mechanism for pipeline 5 is used for keeping the slurry pipeline for the slurry dispensing mechanism 4 refrigerated. The syrup dispensing mechanism 7 delivers the syrup to the outlet mechanism 8. A control panel 11 is provided on the rack 1 for inputting the ratios of the beverage to be prepared.

The slurry dispensing mechanism 4 comprises a canister 41, a liquid pump 42 and a slurry pipeline (not shown in the figures). The canister 41 is installed in the refrigerator box 2. The liquid pump 42 is installed in the installing box 3. The liquid pump 42 is communicated to the canister 41 and the outlet mechanism 8 via the slurry pipeline. The canister 41 is used for storing slurry. The liquid pump 42 is used to pump the slurry stored in the canister 41 to the outlet mechanism 8 through the slurry pipeline. The outlet mechanism 8 receives the slurry to form a beverage.

The refrigerating mechanism for pipeline 5 comprises a cold air interaction box 53, a ventilation structure 54, an air intake structure 51 and an air exchange structure 52. The air intake structure 51 and the air exchange structure 52 are installed in the refrigerating box 2. The cold air interaction box 53 is installed on an upper end of the refrigerating box 2. The refrigerating box 2 is provided with an air exchange channel 23. The cold air interaction box 53 is communicated with the air intake structure 51 and the air exchange structure 52 through the air exchange channel 23. The ventilation structure 54 is installed in the installing box 3, and is communicated with the cold air interaction box 53. The air intake structure 51 comprises a cold air intake fan 511 and an air intake chamber 512. The air intake chamber 512 is installed in the refrigerator box 2. The cold air intake fan 511 is installed in the air intake chamber 512. The air intake chamber 511 is communicated with the cold air interaction box 53 through the air exchange channel 23. The air exchange structure 52 comprises a cold air exchange fan 521 and an air exchange chamber 522. The air exchange chamber 522 is installed in the refrigerator box 2. The cold air exchange fan 521 is installed in the air exchange chamber 522. The air exchange chamber 521 is communicated with the cold air interaction box 53 through the air exchange channel 23. The ventilation structure 54 comprises a ventilation channel 541, an air intake fan 542, and an exhaust fan 543 with the air intake fan 542 and the exhaust fan 543 installed at each end of the ventilation channel 541, respectively. The ventilation channel 541 comprises a transverse channel 544 and two longitudinal channels 545. Two ends of the transverse channel 544 are respectively communicated with the two longitudinal channels 545. The air intake fan 542 and the exhaust fan 543 are respectively installed in the ends of each of the two longitudinal channels 545, so as to increase contact area of the ventilating channel 541 with air. The ventilating channel 541 is a metal component. A refrigerator 22 is provided in the refrigerator box 2 and discharges cold air to refrigerate the refrigerator box 2. The cold air intake fan 511 is activated to extract the cold air from the refrigerator box 2 to the cold air interaction box 53. The air intake fan 542 is activated to take the cold air in the cold air interaction box 53 into the ventilating channel 541. The cold air decreases temperature of the ventilation channel 541, which in turn adsorbs heat in the installing box 3, so that temperature in the installing box 3 is decreased. This realizes refrigerating of the slurry pipeline and prevents the slurry from deteriorating at room temperature, which will affect the taste of the beverage.

The outlet mechanism 8 includes an outlet port 81, a load cell 82, a measuring cup 84,

and an overflow groove 83. The outlet port 81 and the load cell 82 are installed on the rack 1. The outlet port 81 is aligned with the load cell 82. The overflow groove 83 is provided around the load cell 82. The measuring cup 84 is placed on the load cell 82 and is aligned with the outlet port 81. The outlet port 81 is communicated with the slurry dispensing mechanism 4 and the syrup dispensing mechanism 7, respectively, to dispense the slurry and syrup to the measuring cup 84 with different ratios. The load cell 82 is used for identifying dispensing amount of slurry or syrup to ensure that each of beverage is prepared according to preset component weights of different ingredients.

The cleaning system for pipeline 6 includes pipeline for cleaning 67, a cleaning structure, a disinfecting structure, and a descaling structure. The support frame 21 is provided in the refrigerator box 2. The pipeline for cleaning 67 is provided in the support frame 21. The cleaning structure, the disinfecting structure, and the descaling structure are communicated with the pipeline for cleaning 67 respectively so as to clean, disinfect, and descale the pipeline for cleaning 67 and the slurry pipeline one by one. The cleaning structure comprises a cleaning water pump 61, a cleaning connector 62, and a cleaning pipe (not shown in the figure). The cleaning connector 62 is communicated with the cleaning water pump 61 through the cleaning pipe. The cleaning water pump 61 is communicated with the cleaning pipeline 67 through the cleaning pipe. The cleaning connector 62 is used for connecting faucet from outside, so that clean water can be introduced into the bubble tea machine. The disinfecting structure comprises a disinfecting valve 63, a disinfecting connector 64, and a disinfecting pipe (not shown in the figures). The disinfecting connector 64 is communicated with the disinfecting valve 63 through the disinfecting pipe. The disinfecting valve 63 is communicated with the disinfecting pipeline through the disinfecting pipe. The disinfecting connector 64 is connected to a disinfecting bucket from outside, so that disinfecting liquid can be introduced into the bubble tea machine. The descaling structure comprises a descaling valve 65, a descaling connector 66, and a descaling pipe (not shown in the figures). The descaling connector 66 is communicated with the descaling valve 65 through the descaling pipe. The descaling valve 65 is communicated with the descaling pipeline through the descaling pipe. The descaling connector 66 is connected to a descaling bucket from outside so that descaling liquid can be introduced into the bubble tea machine.

When the bubble tea machine needs to be cleaned, the slurry pipeline is disassembled from the canister 41 and is connected with the cleaning pipeline 67 which will be connected to the faucet, a disinfecting bucket and a descaling bucket from outside one by one. The outlet port 81 is connected from outside to a pipeline to a dishwashing sink. Cleaning process is stated by operating the control panel 11 to activate the cleaning so as to activate the water pump 61 to be open. The liquid pump 42 is activated to discharge the slurry in the slurry pipeline by cleaning water into the dishwashing sink through the outlet port 81. The disinfecting valve 63 then is activated to be open, and the liquid pump 42 is activated to pump disinfectant in the disinfecting bucket into the slurry pipeline for disinfecting the slurry pipeline. The descaling valve 65 is activated to be open. The liquid pump 42 is activated to pump descaling liquid in the descaling bucket into the slurry pipeline to descale the slurry pipeline. Finally, the cleaning water pump 61 is activated again to get rid of the disinfecting liquid and the descaling liquid.

The above mentioned embodiments are just the better examples of the present disclosure, and not intended to limit scope of the present disclosure. Any equivalent changes or modifications made in accordance with the structures, features and principles described in the scope of the present disclosure should be fallen in the scope of the present disclosure.

What is claimed is:

1. A refrigerating mechanism for pipeline of an automatic bubble tea machine, comprising a cold air interaction box, a ventilation structure, an air intake structure and an air exchange structure; wherein the air intake structure and the air exchange structure are installed in a refrigerator box; the cold air interaction box is installed on an upper end of the refrigerator box and is communicated with the air intake structure and the air exchange structure; and the ventilation structure is installed in an installing box and is communicated with the cold air interaction box.

2. The refrigerating mechanism for pipeline of an automatic bubble tea machine of claim 1, wherein the air intake structure comprises a cold air intake fan and an air intake chamber; the air intake chamber is installed in the refrigerator box; the cold air intake fan is installed in the air intake chamber; and the air intake chamber is communicated with the cold air interaction box through an air exchange channel.

3. The refrigerating mechanism for pipeline of an automatic bubble tea machine of claim 1, wherein the air exchange structure comprises a cold air exchange fan and air exchange chamber; the air exchange chamber is installed in the refrigerating box; the cold air exchange fan is installed in the air exchange chamber; and the air exchange chamber is communicated with the cold air interaction box through an air exchange channel.

4. The refrigerating mechanism for pipeline of an automatic bubble tea machine of claim 1, wherein the ventilation structure comprises a ventilation channel, an air intake fan and an exhaust fan; and the air intake fan and the exhaust fan are installed at each end of the ventilation channel, respectively.

5. The refrigerating mechanism for pipeline of an automatic bubble tea machine of claim 1, wherein the ventilation channel comprises a transverse channel and two longitudinal channels;
the two ends of the transverse channel are respectively communicated with each of the two longitudinal channels; and the air intake fan and the exhaust fan are respectively installed in one end of each of the two longitudinal channels.

6. The refrigerating mechanism for pipeline of an automatic bubble tea machine of claim 1, wherein the refrigerating box is provided with an air exchange channel; the cold air interaction box is communicated with the air intake structure and the air exchange structure through an air exchange channel.
